(19) United States
(12) Patent Application Publication
(10) Pub. No.: US 2020/0037516 A1
(43) Pub. Date: Feb. 6, 2020

(54) METEOROLOGICAL MODIFICATION METHOD AND APPARATUS

(71) Applicant: David Rubin, Tampa, FL (US)

(72) Inventor: David Rubin, Tampa, FL (US)

(21) Appl. No.: 16/056,102

(22) Filed: Aug. 6, 2018

(51) Int. Cl. A01G 15/00

(52) U.S. Cl. CPC A01G 15/00

(57) ABSTRACT

A method and apparatus for inhibiting or weakening the development of tropical cyclones by detecting the onset of tropical cyclonic activity using conventional weather tracking techniques and using at least one surface vessel to pump chilled subsurface water to cool the surface water in the area of such activity. The chilled subsurface water is obtained by pumping warm surface water down a thermal conductive chilling pipe to depths where the ambient water is very cold and the chilled water is then pumped through nonthermal conducting piping to the surface of the ocean to cool the surface water. The method and apparatus contemplate moving the surface vessel with the movement of the tropical cyclone as tracked by satellite with the objective that cooling activity is optimally positioned and unrelenting.

### BACKGROUND OF THE INVENTION

### 1. Field of the Invention

The present application relates to a meteorological modification method and apparatus for the alteration of certain meteorological phenomena. Incidentally, there are substantially identical meteorological phenomena that are given different names in different parts of the world. In the Atlantic Ocean and eastern Pacific Ocean and adjoining land masses, they are called hurricanes, in the western Pacific Ocean and adjoining land masses they are called typhoons, and in the Indian Ocean and adjoining land masses they are called cyclones. There are even names peculiar to a country, such as “willy-willy” in Australia and “baguio” in the Philippines.

### 2. Description of the Prior Art

The prior art has recognized there exist means to alter some meteorological phenomena. For example, the prior art includes Girden, U.S. Pat. No. 4,245,475, which teaches both the modification of winds moving over water, and the upwelling of cold subsurface water to the surface of warmer water to achieve the phenomenon of altering meteorological events.

Similarly, Girden, U.S. Pat. No. 3,465,964 teaches the modification of winds blowing over water to control smog, and again teaches doing so by the upwelling of cold subsurface water to the ocean surface. And Girden, U.S. Pat. No. 3,683,627 teaches that the temperature of the surface of the ocean can be lowered by the upwelling of cold subsurface water, which is a crucial teaching in the context of the present invention. So also, does Girden, U.S. Pat. No. 4,355,513, which not only teaches the cooling of the surface of water using subsurface water, it teaches that a change on surface water temperature of only one to five degrees can cause winds to blow and gives examples occurring naturally such the coolness of San Francisco summers.

Girden, U.S. Pat. No. 4,245,474 teaches pumping subsurface water to the surface and recites specific pumping rates. In column 8, lines 33 through 44, the rates and horsepower (H.P.) requirements for each of those rates are set forth. For example, in the context of the present invention, only one 250 H.P. pump would produce 500,000 cubic feet per minute, 30 million cubic feet per hour and 720 million cubic feet in a 24 hour day. And that is just with one 250 H.P. pump. Bronicki, et al., U.S. Pat. No. 4,470,544 teaches cooling the surface of the sea using cooler deep water by pumping the cooler deep water to the surface.

Another patent reference is Solc, U.S. Pat. No. 7,798,419 which teaches a method and a device for the reduction of the destructive force of tropical cyclones. It employs using subsurface water pumped above the surface of the ocean. An additional reference is Haber, U.S. Pat. No. 8,256,988, which teaches a method and apparatus which comprise a plurality of interconnected slabs using a series of cables and with cushions placed between the slabs to prevent damage to them. The two final patent references are U.S. Patent Application Publications, both in the name of Uram, Nos. 2002/0008155 and 2005/0133612. These references both teach the use of nuclear powered submarines with large sized pumps to move large quantities of cold subsurface water to the surface of the ocean to quell cyclonic activity.

Beside the prior art in the form of patents and patent application publications, there exist published articles about weather phenomena that constitute prior art in regards to the present invention. The first of these is an article by P. E. Lydolf on Weather and Climate, 11:132-137 published in 1985. Lydolf states unequivocally that an ocean surface water temperature must exceed 80° F. (27° C.) in order for cyclonic storms to form, and that when the storm leaves the warm ocean surface such as by moving to higher latitudes, the storm loses its energy source and the wind speed rapidly drops. In other words, a colder than 80° F. ocean surface will stop a cyclonic storm.

The second non-patent reference is an article by D. E. Ingmanson and W. J. Wallace in the fifth edition of Oceanoqraphy published in 1995. It states 9:144 that tropical cyclones are formed from thunderstorms of a tropical cloud cluster that must be above very warm water, the temperature of which must be above 26° C. (78° F.) and located close to the equator, but far enough away for the Coriolis effect to produce a vigorous eddy to give it rotational motion. It also states at 9:148-9 that a water temperature shift of only a degree or two in patches of the ocean may affect weather around the world. Another non-patent reference is a publication of 1997 entitled Weather Explained. On page 34 is confirmed that tropical cyclones are born only where the seas have a surface temperature of at least 80° F. and that a storm that leaves the area of warm seas dies out. And on page 80, it points out that warm seas are what encourages moist air to rise to form deep rain clouds, which of course is what are needed to form a tropical cyclone. Tropical cyclones feed on warm seawater, and die when deprived of it. The driving energy of tropical cyclones is primarily the heat of condensation, which results from rain that condenses from clouds formed from moisture evaporated from the very warm ocean surface water and then rose to colder temperatures aloft. Typically, the surface temperature of tropical oceans during the relevant season is 85° F. Finally, in 1999, W. K. Stevens in The Change in the Weather confirms that the warmer the sea surface, the more intense is the tropical cyclone.

This application does not assert the present invention can do anything to modify, minimize or terminate a tropical cyclone that has developed into a full blown hurricane, typhoon or cyclone. This application is addressed to modification of a tropical cyclone in its infancy, which in turn requires the operative apparatus be in the right place at the right time. Of course its purpose is ultimately to minimize the formation of hurricanes, but that must be accomplished before the tropical cyclone reaches anywhere near the strength of a hurricane.

Current scientific thinking is that there are things that can be done to affect the strength and path of tropical cyclones. The best example known to the present inventor is an article in the October, 2004 Scientific American. Written by Atmospheric and Environmental Research (Lexington, Mass.) principal scientist and vice president for research and development Ross N. Hoffman, it proposes areas for future research, but outlines amazing results of computer models using simulated hurricanes based upon two real hurricanes, Andrew and Iniki.

What is significant in the context of this application is that Hoffman recognizes the validity of some of the important principles upon which the present invention is predicated. The first of these is that cyclonic storms are susceptible to minor changes in their initial conditions, such as ocean temperature. On page 71, Hoffman states: “A chaotic system [such as a hurricane] . . . is highly sensitive to initial conditions, so that seemingly insignificant, arbitrary inputs can have profound effects that lead quickly to unpredictable consequences. In the case of hurricanes, small changes in such features as the ocean's temperature . . . can strongly influence a hurricane's potential . . . power.” On page 75, Hoffman adds: “If it is true, as our results suggest, that small changes in the temperature in a hurricane can . . . slow its winds, the question becomes, how can such perturbations be achieved?” That is the question answered by the present invention if the cyclonic storm is still in its infancy and not yet near to being a hurricane.

Most hurricanes that affect the East Coast of the U.S. start as “waves” coming off the West African Coast, or in the Gulf of Mexico. Tropical cyclones in the Gulf of Mexico have been known to intensify when passing over higher temperature water, and tropical cyclones in the eastern Pacific have diminished as they have passed over the cool water west of Baja California. Similarly, the western south Atlantic adjacent to Brazil has never experienced hurricanes because the sea temperature there is too cold for the formation of storms.

While the development of a tropical cyclone can be detected in “real time” on weather satellites as early as when it becomes a tropical depression, to the present time there has been no practical way by which a relatively small input of energy will be effective to inhibit or weaken the development of a tropical cyclone. The notion of pumping cold subsurface water to the surface has been described in the prior art, but is not known to have been done using submerged nuclear powered submarines positioned and moved using data from weather satellites in synchronous orbit of the earth. Several prior art references teach that apparatus for that purpose. See, for example US Patent Application Nos. 2002/0008155 and 2005/0133612. One reason for that is the US Navy is not likely to permit use of such equipment for that purpose.

But the same objective can be accomplished using a surface vessel and solar power as described in the present application.

The present invention also avoids the consumption of large amounts of power required to lift cold water from deep in the ocean by using surface water that is pumped down to chill it and back up to the surface to cool the surface. Chilling is accomplished through the walls of a steel descending pipe, which temperature is somewhat retained by the relatively insulated walls of a plastic ascending pipe, e.g., PVC pipe. Relatively little power is needed because the weight of the descending water is largely balanced by the weight of the ascending water. Because the work load is minimized by the relatively balanced weight between the descending water and the ascending water, the apparatus can be powered by solar panels of a size that are practical for placement on a surface vessel.

### SUMMARY OF THE INVENTION

Bearing in mind the foregoing, it is a principal object of the present invention is to provide a method for inhibiting or weakening the development of tropical cyclones in their infancy.

Another principal object of the invention is to provide apparatus to inhibit or weaken the development of tropical cyclones in their infancy.

An additional object of the invention is to put together aspects of existing known technology, such as surface vessels, solar power, steel and plastic pipes with varying heat transfer coefficients, weather satellite storm tracking data, the notion of cold subsurface water being pumped to the ocean surface to affect meteorological phenomenon, and the effect of chilled surface ocean water on tropical cyclones, in a combination previously unknown to inhibit or weaken the development of tropical cyclones in their infancy.

In accordance with a principal aspect of the present invention, there is provided a surface vessel equipped with an array of photo voltaic (PV) panels to provide power to a pumping apparatus. The pumping apparatus has an intake near the water surface of the ocean on which the vessel is deployed. The intake water passes through a pump and piping that is disposed downward from the vessel hull to a depth of what may be at or near 3000 feet. This downward portion of the pipe is referred to the chilling portion because it is made from thermal conducting material such as steel. As will be seen in regard to FIG. 1, the temperature of the ambient water drops to near freezing temperatures at a depth near 3000 feet. Therefore water passing through the chilling portion of the downward portion of the pipe is greatly chilled because of the thermal conduct activity of that portion of the pipe.

At or near its deepest point the composition of the pipe is changed to a non-temperature conducting material such as plastic. This portion of the pipe ascends to near the surface of the water, but retains most of its temperature because of the thermal nonconductive nature of the material from which the ascending pipe is made.

Most importantly, a major advantage of the present invention is the work load minimization aspects of the heat transfer mechanism of the present invention, which relies upon solar power to operate the motor driven pump(s) at the core of the heat transfer assembly. Seawater is a substantially incompressible fluid. So therefore the different temperatures of the seawater descending in the chilling portion of the heat transfer assembly has minimal impact compared to the colder temperature of the water contained in the rising insulated pipe portion of the heat transfer assembly. Put another way, because the weight of the water in the descending portion of the pipe is substantially similar to the weight of the water in the ascending portion of the pipe, a considerable portion of the work performed by the pumping apparatus is mostly limited to friction.

This feature is referred to in this application, and especially in its claims, as the work load minimization aspects of the invention.

### BRIEF DESCRIPTION OF THE DRAWINGS

Various other features of the invention will become apparent to those skilled in the art from the following discussion taken in conjunction with the appended drawings, in which:

FIG. 1 is a thermal Klein, which is a graphical representation of the decrease in ocean temperature as it is measured in distance from the surface.

FIG. 2 illustrates a surface vessel on the ocean which includes the apparatus of the present invention and wherein the vessel is towing a photo voltaic array. Alternatively, a decommissioned aircraft carrier would achieve the same purpose.

### DETAILED DESCRIPTION OF PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various figures are designated by the same reference numerals.

As indicated earlier, the present invention inhibits or weakens the development of tropical cyclones in their infancy by cooling the surface water in the ocean upon the detection of same in real time by storm tracking weather satellites.

Atlantic hurricanes start off the coast of Africa and move west and north. Is the purpose of the present invention to chill the upper layer of these waters to reduce the energy that drives these cyclonic events.

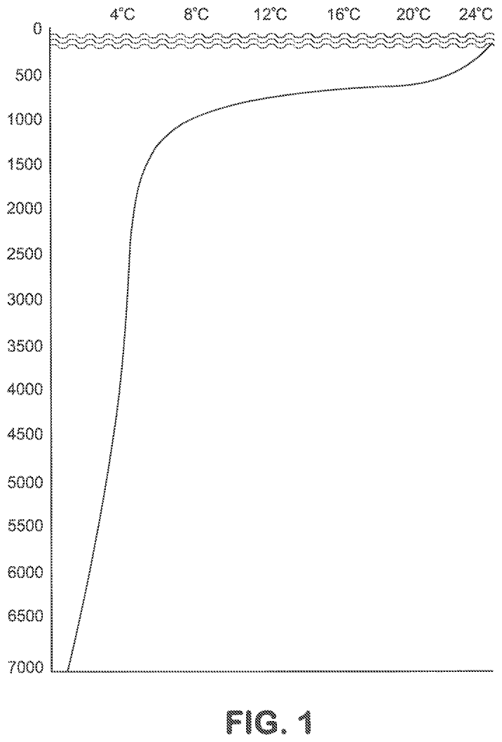

The method is to send surface water down to approximately 2 to 3000 feet in a metal pipe and bring it back up in a plastic pipe that will retain the cold on its way to the surface. Water temperature is colder as it gets deeper in the ocean and the temperature falls to near 0° F. at 3000 feet of depth. Reference is made to FIG. 1 which is a thermocline.

The metal pipe will allow the water to get much colder on the way down because the metal pipe is a thermal conductor, while the plastic pipe is a relative thermal insulator. The heat transfer assembly is advantageously designed to minimize work load on the solar powered DC motor driven pump(s).

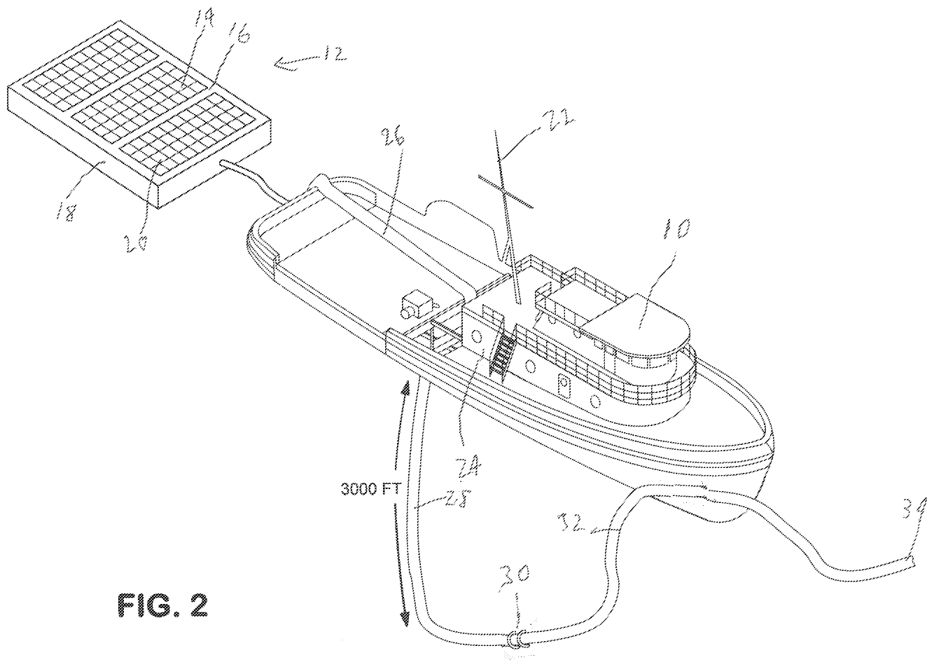

The apparatus of the present invention is placed aboard a surface vessel 10 which is comprised of a photo voltaic system 12 having a solar array 14. In FIG. 2 the vessel 10 illustrated as being a conventional hull towing a barge, but it should be understood that the invention contemplates that the solar array 14 could be mounted upon the surface vessel 10 if it's all were sufficiently extended to support and adequately sized solar array 14, thereby eliminating the existence of the barge, such as if a decommissioned aircraft carrier were the surface vessel.

The solar array 14 is interspersed with walkways 16 to facilitate maintenance and repair of the solar arrays 14 and to provide access to batteries disposed beneath the solar arrays. These batteries 18 provide storage of power created during the daytime so that power is available. In other words the power supply during the day time must be sufficient to operate a DC motor driven pump 24 during the day time and also sufficient to charge the batteries 18 so that the DC motor driven pump can normally be operated 24 hours per day. The solar arrays 14 may optionally be mounted on tilting racks 20 as controlled by a solar tracking system 22. The tilting racks 20 are optional because the vessel is expected to be used very near to the equator where a fair degree of efficiency is obtainable without having the means to follow the sun in a manner dictated by a solar tracking system 22.

The one or more pumps are preferably DC motor driven 24 because the photo voltaic system 12 produces power that is DC which is efficiently employed by a DC motor. Alternatively the apparatus of the present invention can be supplied with an AC powered pump and an inverter. Such a choice is less efficient than the use of a DC driven motor pump 24. Of course with either system, there may be need for additional electrical accessories such as a charge controller, power conditioning equipment, a GPS solar tracker, energy management software, solar radiation sensors, a cooling system, an anemometer, series or parallel wiring, etc.

Warm surface seawater is brought aboard surface vessel 10 using intake line 26, where it passes through the DC motor driven pump 24 and then is discharged through chilling pipe 28. The latter is so named because it is comprised of a thermal conducting material such as steel. Accordingly as warm surface seawater passes through it that water is severely chilled because the ambient water outside the pipe is much colder water as illustrated in the thermocline of a FIG. 1. After being severely chilled to temperatures approaching those illustrated in FIG. 1.

The water passes through pipe junction 30 and then enters rising insulated pipe 32. Rising insulated pipe 32 is so named because it is fabricated from a relatively well insulated material such as PVC. Rising insulated pipe 32 discharges the severely chilled water on or near the surface of the ocean at discharge port 34. It thereafter chills surface water to below 80° F. below which temperature cyclonic activity is not possible according to the prior art hereinabove recited. The assembly downstream of DC motor driven pump 24, which includes chilling pipe 28, pipe junction 30, and rising insulated pipe 32 is collectively termed the “heat exchanger assembly” which is configured with a “work load minimization” feature.

While the invention has been described, disclosed, illustrated and shown in various terms or certain embodiments or modifications, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1-57. (canceled)

58. A method of inhibiting development of a tropical cyclone over warm ocean water, comprising:
positioning at least one surface vessel beneath the tropical cyclonic activity, in which the surface vessel is equipped with at least one motor driven pump, a photo voltaic system to power the pump, and a heat exchanger assembly that includes a work load minimization feature;
pumping warm ocean surface water through an inlet pipe and through the pump;
pumping the warm ocean surface water through the heat exchanger assembly having a chilling pipe; and
pumping the heat exchanger chilled water through a discharge port to cool the warm ocean surface water.

59. The method of claim 58, wherein the surface water is chilled by effecting heat transfer between the surface water and subsurface water adjacent to the chilling pipe.

60. The method of claim 59 wherein the water chilled in the chilling pipe is maintained as cold as possible in a rising insulated pipe enroute to the discharge port.

61. The method of claim 58 in which the chilling pipe is fabricated from steel.

62. The method of claim 60 in which the rising insulated pipe is PVC pipe.

63. The method of claim 58 in which the pump is DC motor driven.

64. The method of claim 58 in which pump is AC motor driven and further comprises an inverter to convert DC power to AC power.

65. An apparatus for inhibiting development of a tropical cyclone over warm ocean water comprising:
at least one surface vessel having at least one motor driven pump in fluid communication with warm ocean surface water through an inlet pipe and also with a heat exchanger assembly that includes a work load minimization feature that discharges chilled water to the ocean surface, and a photo voltaic system to power the pump.

66. The apparatus of claim 65 which further comprises a pump that is driven by a DC motor for efficiency when using DC power from a photo voltaic system.

67. The apparatus of claim 65 which further comprises a pump that is AC motor driven and includes an inverter to convert DC power from the photo voltaic system to AC power.

68. The apparatus of claim 65 which further comprises a heat exchanger having a chilling pipe fabricated from steel to achieve an efficient heat transfer rate between warm ocean surface water and very cold ambient subsurface ocean water.

69. The apparatus of claim 65 which further comprises rising insulated pipe that is fabricated from PVC.
